(19) United States
(12) Patent Application Publication
(10) Pub. No.: US 2026/0323036 A1
(43) Pub. Date: Oct. 15, 2026

(54) REMOVING SOME REDUNDANCIES IN MOTION INFORMATION CODING

(71) Applicant: InterDigital CE Patent Holdings, SAS, paris (FR)

(72) Inventors: Fabrice LE LEANNEC, BETTON (FR); Tangi POIRIER, THORIGNE-FOUILLARD (FR); Franck GALPIN, THORIGNE-FOUILLARD (FR); Pascal LE GUYADEC, ST GREGOIRE (FR); Antoine ROBERT, MEZIERES SUR COUESNON (FR)

(21) Appl. No.: 19/484,279

(22) PCT Filed: Apr. 26, 2024
(86) PCT No.: PCT/EP2024/061519

§ 371 Date: Nov. 13, 2025

(30) Foreign Application Priority Data
May 15, 2023 (EP) 23305765.2
Jan. 9, 2024 (EP) 24305047.3

(51) Int. Cl. H04N 19/139; H04N 19/176

(52) U.S. Cl. CPC H04N 19/139; H04N 19/176

(57) ABSTRACT

A method comprising: decoding (1001) and index of a first motion information predictor in an initial list of motion information predictors for a current block of a picture; decoding (1002) a motion information difference for the current block; and, applying (1003, 1004) a validity checking process comprising determining from a criterion calculated from the motion information difference and the motion information predictors of the initial list that the first motion information predictor and the motion information difference form a valid combination; and, adapting (1005) the initial list of motion information predictors to obtain an adapted list based on a result of the applying of the validity checking process.

### 1. CROSS REFERENCE TO RELATED APPLICATIONS

This application claims priority to European Application No. 23305765.2, filed May 15, 2023 and to European Application No. 24305047.3 filed Jan. 9, 2024, which are incorporated herein by reference in their entirety.

### 2. TECHNICAL FIELD

At least one of the present embodiments generally relates to a method and a device for improving encoding of motion information in video compression methods.

### 3. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

Inter prediction consists in predicting a current block of a current picture from at least one predictor block from a reference picture preceding or following the current picture. A predictor block is identified in the reference picture by motion information. As the video compression methods evolve, the coding of the motion information has been greatly improved. In particular, motion information is now predicted using methods such Adaptive Motion Vector Prediction (AMVP) or merge. Basically, these methods comprise a construction of a list of motion vector predictors (MVPs), a selection of a best MVP in the list and an encoding of the motion vector of the current block in the form of an index representing the selected MVP along, in some cases, a motion difference between the selected MVP and the actual motion vector of the current block.

It appears that the representation of a motion vector in the form of an index of an MVP along with a motion vector difference carry some redundant (or residual) information on some characteristics of the motion. The existence of such residual motion information could be considered as indicating that the representation of the motion vector is sub-optimal and could still be improved.

It is desirable to propose solutions allowing to overcome the above issues. In particular, it is desirable to propose solutions improving the coding of the motion information.

### 4. BRIEF SUMMARY

In a first aspect, one or more of the present embodiments provide a method comprising:
decoding an index of a first motion information predictor in an initial list of motion information predictors for a current block of a picture;
decoding a motion information difference for the current block; and,
applying a validity checking process comprising determining from a criterion calculated from the motion information difference and the motion information predictors of the initial list that the first motion information predictor and the motion information difference form a valid combination; and,
adapting the initial list of motion information predictors to obtain an adapted list based on a result of the applying of the validity checking process.

In an embodiment, responsive to the first motion information predictor and the motion information difference form a non-valid combination, adapting the initial list comprises replacing the first motion information predictor by an alternative motion information predictor, the alternative motion information predictor being determined based on the motion information predictors of the initial list.

In an embodiment, determining the alternative motion information predictor based on the motion information predictors of the initial list comprises comparing a norm of the motion information difference with a value representative of the lowest norm of norms of the motion information predictors of the initial list and selecting the alternative motion information predictor among a motion information predictor derived from the motion information predictors of the initial list and a zero motion vector based on a result of the comparison.

In an embodiment, the zero motion vector is selected responsive to a ratio between the norm of the motion information difference and the a value representative of the lowest norm of the norms of the motion information predictors of the initial list is lower than a value.

In an embodiment, the initial list of motion information predictors comprises the first motion information predictor and a second motion information predictor, and the criterion is based on the first motion information predictor and the second motion information predictor.

In an embodiment, responsive to the first motion information predictor and the motion information difference form a non-valid combination, adapting the initial list comprises replacing the first motion information predictor by an alternative motion information predictor corresponding to a candidate selected among potential candidates considered during an AMVP and/or merge candidates list construction process.

In an embodiment, the selected candidate is such that a value representative of a difference between the selected candidate and the second motion information predictor is higher than a value.

In an embodiment, the method comprises reconstructing the motion information of the current block as a sum of the alternative motion information predictor and the motion information difference.

In a second aspect, one or more of the present embodiments provide a method comprising:
obtaining a first motion information predictor of an initial list of motion information predictors for a current block of a picture;
computing a motion information difference between a motion information of the current block and the first motion information predictor;
applying a validity checking process comprising determining from a criterion calculated from the motion information difference and the motion information predictors of the initial list that a second motion information predictor of the initial list and the motion information difference form a valid combination; and,
adapting the initial list of motion information predictors to obtain an adapted list based on a result of the applying of the validity checking process.

In an embodiment, responsive to the first motion information predictor and the motion information difference form a non-valid combination, adapting the initial list comprises replacing the first motion information predictor by an alternative motion information predictor, the alternative motion information predictor being determined based on the motion information predictors of the initial list; and recomputing the motion information difference based on the adapted list comprises recomputing the motion information difference as a difference between the motion information of the current block and the alternative motion information predictor.

In an embodiment, determining the alternative motion information predictor based on the motion information predictors of the initial list comprises comparing a norm of the motion information difference with a value representative of a lowest norm of norms of the motion information predictors of the initial list, selecting the alternative motion information predictor among a motion information predictor derived from the motion information predictors of the initial list and a zero motion vector based on a result of the comparison.

In an embodiment, the zero motion vector is selected responsive to a ratio between the norm of the motion information difference and the value representative of the lowest norm of the norms of the motion information predictors of the initial list is lower than a value.

In an embodiment, the initial list of motion information predictors comprises the first motion information predictor and a second motion information predictor, and the criterion is based on the first motion information predictor and the second motion information predictor.

In an embodiment, responsive to the first motion information predictor and the motion information difference form a non-valid combination, adapting the initial list comprises replacing the first motion information predictor by an alternative motion information predictor corresponding to a candidate selected among potential candidates considered during an AMVP and/or merge candidates list construction process.

In an embodiment, the selected candidate is such that a value representative of a difference between the selected candidate and the second motion information predictor is higher than a value.

In an embodiment, the method comprises encoding the motion information of the current block in the form of an index representative of the first motion information predictor and the recomputed motion information difference.

In a third aspect, one or more of the present embodiments provide a device comprising electronic circuitry configured for:
decoding an index of a first motion information predictors in an initial list of motion information predictors for a current block of a picture;
decoding a motion information difference for the current block; and,
applying a validity checking process comprising determining from a criterion calculated from the motion information difference and the motion information predictors of the initial list that the first motion information predictor and the motion information difference form a valid combination; and,
adapting the initial list of motion information predictors to obtain an adapted list based on a result of the applying of the validity checking process.

In an embodiment, responsive to the first motion information predictor and the motion information difference form a non-valid combination, adapting the initial list comprises replacing the first motion information predictor by an alternative motion information predictor, the alternative motion information predictor being determined based on the motion information predictors of the initial list.

In an embodiment, determining the alternative motion information predictor based on the motion information predictors of the initial list comprises comparing a norm of the motion information difference with a value representative of the lowest norm of norms of the motion information predictors of the initial list and selecting the alternative motion information predictor among a motion information predictor derived from the motion information predictors of the initial list and a zero motion vector based on a result of the comparison.

In an embodiment, the zero motion vector is selected responsive to a ratio between the norm of the motion information difference and the a value representative of the lowest norm of the norms of the motion information predictors of the initial list is lower than a value.

In an embodiment, the initial list of motion information predictors comprises the first motion information predictor and a second motion information predictor, and the criterion is based on the first motion information predictor and the second motion information predictor.

In an embodiment, responsive to the first motion information predictor and the motion information difference form a non-valid combination, adapting the initial list comprises replacing the first motion information predictor by an alternative motion information predictor corresponding to a candidate selected among potential candidates considered during an AMVP and/or merge candidates list construction process.

In an embodiment, the selected candidate is such that a value representative of a difference between the selected candidate and the second motion information predictor is higher than a value.

In an embodiment, the electronic circuitry is further configured for reconstructing the motion information of the current block as a sum of the alternative motion information predictor and the motion information difference.

In a fourth aspect, one or more of the present embodiments provide a device comprising electronic circuitry configured for:
obtaining a first motion information predictor of an initial list of motion information predictors for a current block of a picture;
computing a motion information difference between a motion information of the current block and the first motion information predictor;
applying a validity checking process comprising determining from a criterion calculated from the motion information difference and the motion information predictors of the initial list that a second motion information predictor of the initial list and the motion information difference form a valid combination; and,
adapting the initial list of motion information predictors to obtain an adapted list based on a result of the applying of the validity checking process.

In an embodiment, responsive to the first motion information predictor and the motion information difference form a non-valid combination, adapting the initial list comprises replacing the first motion information predictor by an alternative motion information predictor, the alternative motion information predictor being determined based on the motion information predictors of the initial list; and recomputing the motion information difference based on the adapted list comprises recomputing the motion information difference as a difference between the motion information of the current block and the alternative motion information predictor.

In an embodiment, determining the alternative motion information predictor based on the motion information predictors of the initial list comprises comparing a norm of the motion information difference with a value representative of a lowest norm of norms of the motion information predictors of the initial list, selecting the alternative motion information predictor among a motion information predictor derived from the motion information predictors of the initial list and a zero motion vector based on a result of the comparison.

In an embodiment, the zero motion vector is selected responsive to a ratio between the norm of the motion information difference and the value representative of the lowest norm of the norms of the motion information predictors of the initial list is lower than a value.

In an embodiment, the initial list of motion information predictors comprises the first motion information predictor and a second motion information predictor, and the criterion is based on the first motion information predictor and the second motion information predictor.

In an embodiment, responsive to the first motion information predictor and the motion information difference form a non-valid combination, adapting the initial list comprises replacing the first motion information predictor by an alternative motion information predictor corresponding to a candidate selected among potential candidates considered during an AMVP and/or merge candidates list construction process.

In an embodiment, the selected candidate is such that a value representative of a difference between the selected candidate and the second motion information predictor is higher than a value.

In an embodiment, the electronic circuitry is further configured for encoding the motion information of the current block in the form of an index representative of the first motion information predictor and the recomputed motion information difference.

In a fifth aspect, one or more of the present embodiments provide a computer program comprising program code instructions for implementing the method according to the first or the second aspect.

In a sixth aspect, one or more of the present embodiments provide a non-transitory information storage medium storing program code instructions for implementing the method according to the first or the second aspect.

### 5. BRIEF SUMMARY OF THE DRAWINGS

FIG. 1 illustrates an example of context in which various embodiments may be implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIGS. 6A and 6B and illustrates schematically spatial and temporal positions considered for constructing a list of merge candidates;

FIGS. 7A and 7B illustrates motion coding configurations in AMVP mode;

FIG. 8A illustrates an example of motion vector reconstruction process at a decoder side of an embodiment;

FIG. 8B illustrates an example of motion vector reconstruction process at an encoder side of an embodiment;

FIGS. 9, 11 and 13 illustrate various embodiments of an encoding algorithm; and,

FIGS. 10, 12 and 14 illustrate various embodiments of a decoding algorithm.

### 6. DETAILED DESCRIPTION

The following examples of embodiments are described in the context of a video format similar to VVC (ISO/IEC 23090-3-MPEG-I. Versatile Video Coding (VVC)/ITU-T H.266). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9.

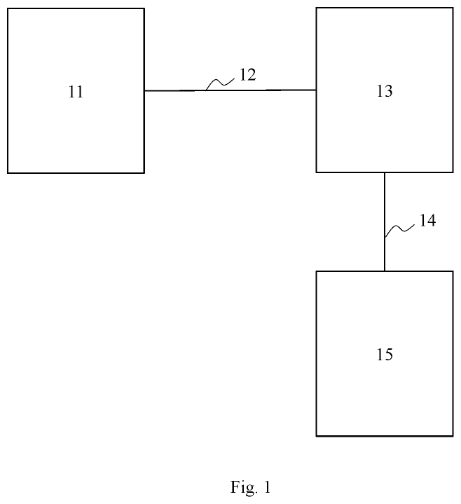

FIG. 1 describes an example of a context in which following embodiments can be implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display 15 are comprised in a TV, a computer, a tablet, a smartphone, a head-mounted display, etc.

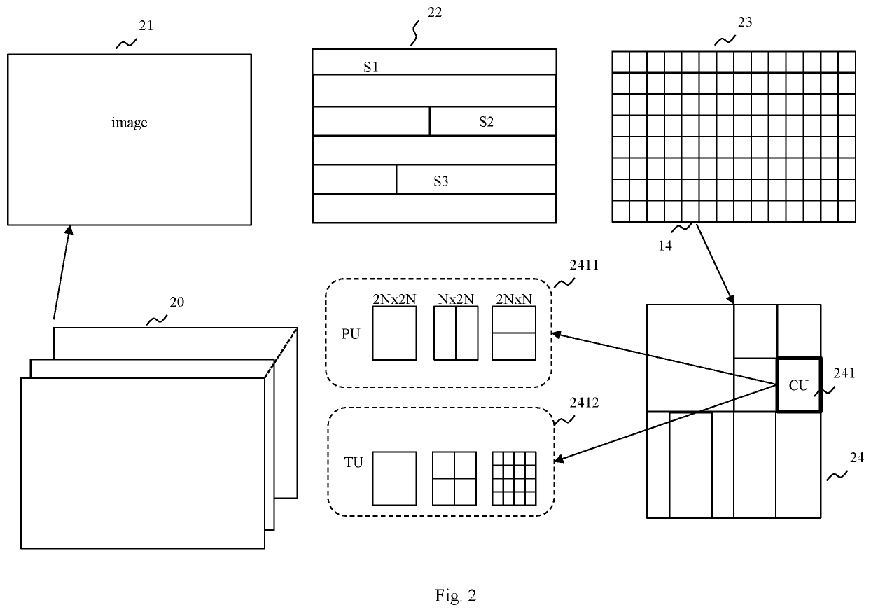

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. Nis generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 1, a CU of size 2N×2N, can be divided in PU 2411 of size N×2N or of size 2N×N. In addition, said CU can be divided in “4” TU 2412 of size N×N or in “16” TU of size (N/2)×(N/2).

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

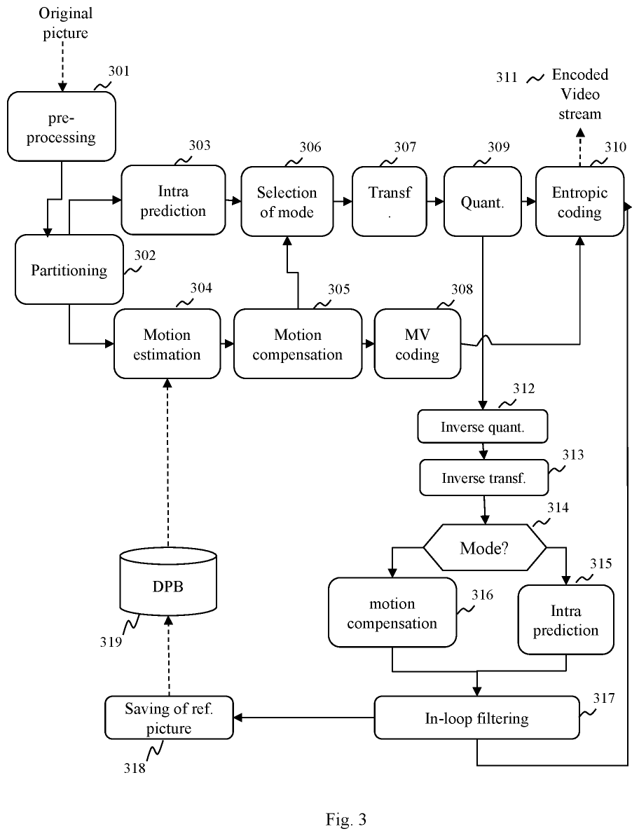

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction mode indicating which pixels of the blocks in the vicinity to use, and a residual block resulting from a calculation of a difference between the current block and the prediction block.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305, involving interpolation operations between samples of the reference block, to generate a prediction block. A residual block is then calculated in the form of a difference between the current block and the prediction block. In first video compression standards, the uni-prediction inter mode described above was the only inter mode available. As video compression standards evolve, the family of inter modes has grown significantly and comprises now many different inter modes, such as bi-prediction modes in which a current is predicted from two reference blocks designated by two different motion information.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. In some implementations, a plurality of type of transforms can be applied to a transformed residual block. Indeed, in addition to DCT-II, a Multiple Transform Selection (MTS) scheme is used for both inter and intra predicted blocks. It uses multiple selected transforms from the DCT-VIII/DST-VII.

The transformed block is then quantized during a step 309.

Note that the encoding module can skip the transform and apply quantization directly to the non-transformed residual signal.

The quantized residual block determined for the current block during an inter or intra prediction is encoded by an entropic encoder during a step 310. Note that the encoding module can bypass both transform and quantization, i.e., the entropic encoding is applied on the residual without the application of the transform or quantization processes. The result of the entry coding is inserted in the video data 311.

When the current block is coded according to an intra prediction mode, the intra prediction mode is encoded by the entropic encoder during the step 310 in the video data 311.

When the current block is encoded according to an inter prediction, a process is applied to encode the motion information. The output of this process is then encoded by the entropic encoder during the step 310 in the video data 311.

Two processes are employed to encode the motion information: AMVP (Adaptive Motion Vector Prediction) or Merge. In each process, the motion information is predicted.

In an implementation of the AMVP mode, a motion vector predictor (MVP) is selected, and a motion vector difference noted MVd relative to the selected MVP is computed. The MVP is selected in a list of AMVP candidates made of “2” candidates. The index of the chosen MVP and the MVd are then encoded by the entropic encoder during step 310 along with the transformed and quantized residual block resulting from the inter prediction of the current block.

The AMVP candidate list is constructed first by deriving a first spatial candidate from a left block neighbouring the current block, if this block is available and inter coded. Then a second spatial candidate is derived from a top block neighbouring the current block, if this block is available and inter coded. Then, a temporal candidate is derived from a so-called collocated picture of current picture, which is an already coded picture close to current picture, at a position collocated with the current block, if an inter block exist at this collocated position. Each derived MVP candidate is scaled according to a temporal distance between the reference picture associated to this MVP candidate and the reference picture considered for the current block. A redundancy check is then conducted between derived spatial candidates and, if a duplicate candidate exists, this candidate is discarded. The final AMVP candidate list contains the two first derived MVP candidates. If less than “2” MVP candidates are obtained through the above process, then the AMVP candidate list is completed with zero motion vectors.

The merge mode consists in deriving motion information of a current block from a selected motion information predictor candidate. The motion information considered here includes all the inter prediction parameters of a block, that is to say: the uni-prediction or bi-prediction type, the reference picture index within each reference picture list and the motion vector(s). The selected motion information predictor candidate (i.e., the merge candidate) is selected in a list of motion information predictor candidates (i.e., in a list of merge candidates). When a block is encoded in merge mode, the index of the selected merge candidate is encoded. If no residual block is encoded for the current block, the current block is considered as encoded according to a particular merge mode called skip mode.

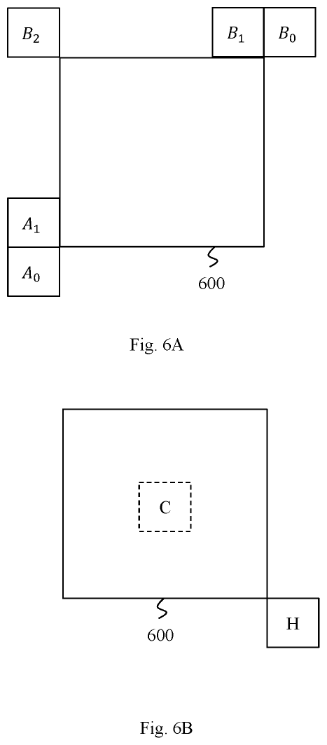

In some implementations, the list of merge candidates is systematically made of “5” merge candidates. Up to “5” spatial positions are considered to retrieve some potential candidates for the list of merge candidates. FIG. 6A illustrates schematically the five spatial positions considered for constructing a list of merge candidates. These positions are investigated according to the following order:
1. Left (A1)
2. Above (B1)
3. Above right (B0)
4. Left bottom (A0)
5. Above left (B2)

Each spatial candidate is introduced in the list of merge candidates provided that the motion information corresponding to this candidate is not already present in the list of merge candidates.

Then a temporal predictor noted TMVP is determined. FIG. 6B illustrates schematically collocated positions considered for determining the TMVP. The determination of the TMVP consists first in investigating position H and, if no motion information is available at position H, the position C is investigated.

A last pruning process is then applied to ensure that the set of spatial and temporal candidates does not contain redundant candidates.

In case of B-slice (slice allowing bi-predicted blocks), candidates of another type, called combined candidates, are introduced in the list of merge candidates if this list is not full.

Finally, if the merge list is still not full then zero motion vectors are introduced at the end of the merge list until it is full.

Recently, the representation of the motion information has slightly evolved with the apparition of two main categories of motion representation: the whole-block-based motion representation and the sub-block-based motion representation.

The whole-block-based motion representation consists in assigning one set of motion information, made of one or two motion vectors and associated reference picture(s) to an inter block. Thus, the motion information of that block is represented under the form of one or two motion vectors for the whole block and a reference picture associated to each motion vector.

Sub-block-based motion coding mode typically consists in dividing a block into 4×4 or 8×8 luma samples subblocks and assigning an individual set of motion information (one or two couples of a motion vector and a reference picture) to each subblock.

While in previous implementations of AMVP only spatial candidates, temporal candidates and the zero-motion vector candidate were considered for constructing the list of AMVP candidates, a new category of candidates, called HMVP (History-Based Motion Vector Prediction) candidates, was added in AMVP implementations adapted to the whole block-based motion representation.

A principle of HMVP candidates is to use previously coded motion vectors as MVPs. These motion vectors are associated with adjacent or non-adjacent blocks relative to a current block. To do so, a table of HMVP candidates (i.e., HMVP table) is maintained and updated on the fly, as a first-in-first-out (FIFO) buffer of MVPs. There are up to five candidates in the HMVP table. After coding one inter predicted block, provided that this block is not in sub-block mode (including affine mode) or GPM (geometric partition mode), the HMVP table is updated by appending the motion information of an inter predicted block to the end of the HMVP table as a new HMVP candidate. In addition to the usual FIFO rule, a mechanism to remove redundant HMVP candidates is applied. One can note that the HMVP table is reset at each CTU row to enable parallel processing.

In recent implementations of the merge mode adapted to the whole block-based representation, the list of merge candidates was modified and three new merge modes were introduced.

The list of merge candidates is constructed with the following types of candidates:
Spatial candidates.
Temporal candidates.
HMVP candidates. Several HMVP candidates are inserted into the list of merge candidates so that the list reaches a maximum allowed number of merge candidates minus 1.
Pairwise Average candidates. Up to one pairwise average candidate is added to the list of merge candidates. Pairwise candidates are computed as follows: the two first merge candidates present in the list of merge candidates are considered and their motion vectors are averaged. This averaging is computed separately for each reference picture list. If each of the two first merge candidates are bi-prediction ones, motion vectors related to both lists L0 and L1 are averaged. If only one motion vector is present, it is taken as is to form the pairwise candidate.
5. Zero motion vector candidate.

The three new merge modes comprise MMVD (Merge Mode with motion vector Difference), GPM (Geometric Partitioning Mode) and CIIP (Combined Intra/Inter Prediction). These new modes are detailed in document JVET-T2002-v2: Algorithm description for Versatile Video Coding and Test Model 11 (VTM 11), Joint Video Experts Team (JVET) of ITU-T SG 16 WP 3 and ISO/IEC JTC 1/SC 29, 20th Meeting, by teleconference, 7-16 Oct. 2020, Jianle Chen, Yan Ye, Seung Hwan Kim.

MMVD can be viewed as a kind of merge mode in which a merge candidate is refined by a MVd. In MMVD, after a merge candidate is selected, it is further refined by a signalled MVd information. The signaling of a MMVD mode comprises a merge candidate flag, an index to specify a motion magnitude and an index indicating a motion direction. The merge candidate flag is signalled to specify which one is used between the first and second merge candidates. The index specifying a motion magnitude and the index indicating a motion direction allow signaling a limited number of motion vector differences (MVd) on top of a signaled merge candidate, i.e., “4” vector directions and “8” magnitude values.

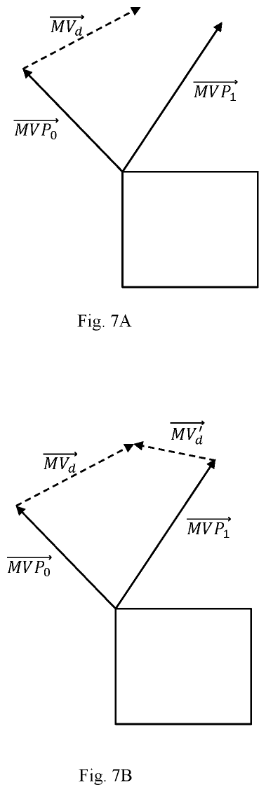

FIG. 7A illustrates a motion coding configuration in AMVP mode. A block to predict is shown together with his two AMVP motion vector prediction candidates \vec{MVP₀} and \vec{MVP₁}, and a motion vector difference \vec{MV_{d}} to signal.

It is established that, in existing implementations of AMVP, the coding cost of a motion difference is highly correlated to the magnitude of the motion vector difference and increases as a function of the \vec{MV_{d}} magnitude.

FIG. 7B shows that the coding configuration of the FIG. 7A can also be reached by using the motion vector predictor \vec{MVP₁} instead of \vec{MVP₀}, leading to a smaller motion vector difference magnitude.

In the following embodiments, it is shown that the situation of FIG. 7A can be detected as non-optimal by a decoding module. Indeed, in these embodiments, the decoder is able to detect that the use of motion vector predictor \vec{MVP₀} is not the most optimal one to employ for pointing to the spatial position corresponding to \vec{MVP₀}+\vec{MV_{d}}, as shown in FIG. 7B. The decoder is able to detect that the use of motion vector predictor \vec{MVP₁} is the most likely one, compared to \vec{MVP₀}. Therefore, it can be considered that in the configuration of FIG. 7A, the signaling of the motion vector predictor using an index of the chosen motion vector predictor and the motion vector difference carry some redundant (or residual) information that can be exploited.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion information of the current block in order to identify each reference block of the current block. If the current block is encoded according to an intra prediction mode, during a step 315, the intra prediction mode is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

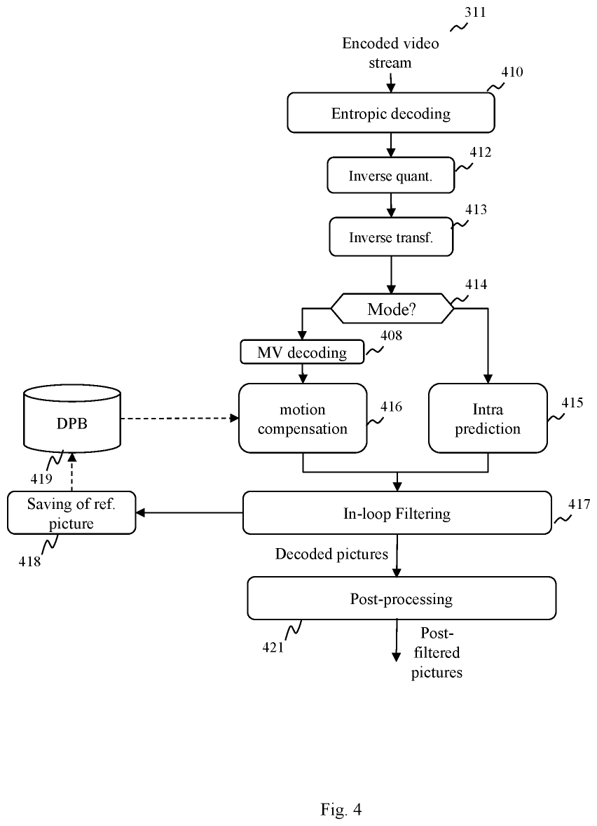

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropic decoding allows to obtain, when appropriate, information representative of a motion of the current block and a residual block. During a step 408, the motion information is reconstructed for the current block using the decoded information representative of the motion information. In AMVP, the information representative of the motion comprises an index of the AMVP MVP in the AMVP list and the MVd. The MVd is then added to the AMVP MVP to reconstruct the motion vector of the block. In merge, an index of the merge MVP in the merge list is obtained. The merge MVP corresponding to the index provides the motion information of the current block. In MMVD, the information representative of the motion of the current block comprises some MMVD indices representative of a MVd. The MVd corresponding to the MMVD indices is then added to the merge MVP to determine the motion information of the current block.

If the block has been encoded according to an intra prediction mode, entropic decoding allows to obtain the intra prediction mode and a residual block. Steps 412, 413, 414, 415, 416 and 417 implemented by the decoding module are in all respects identical respectively to steps 412, 413, 414, 415, 416 and 417 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given image. The decoded picture can also be outputted by the decoding module for instance to be displayed.

The post-processing step 421 can comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

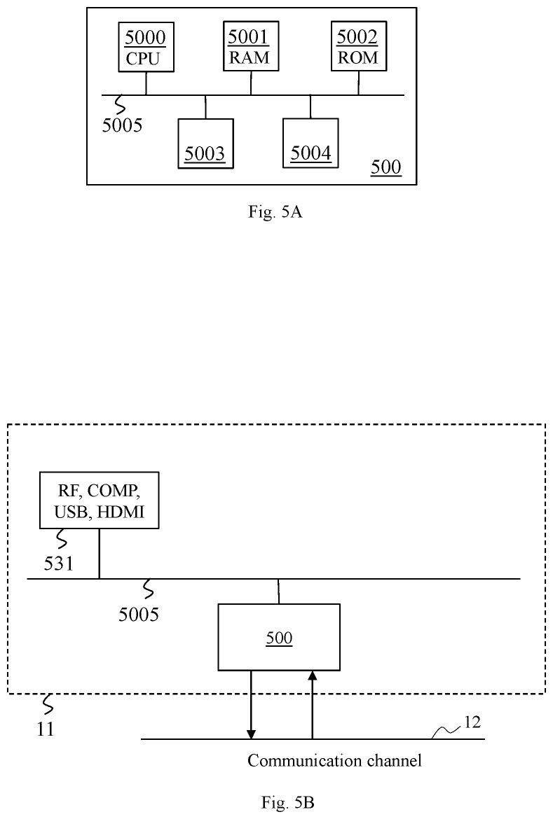

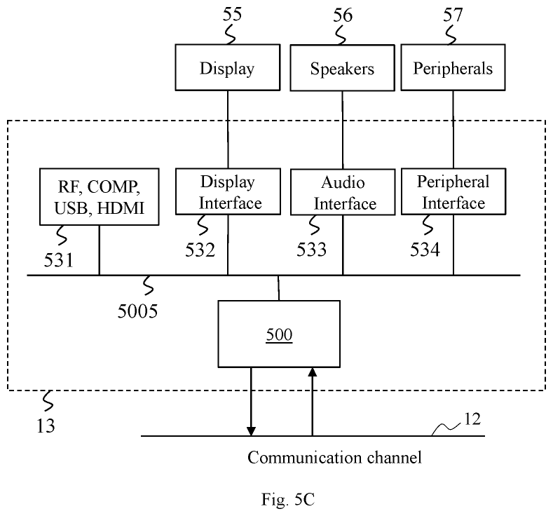

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this apparatus is in charge of encoding the video stream. The decoding module is for example comprised in the system 13. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4, an encoding method described in relation to FIG. 3, and methods described in relation to FIG. 6 or 7, these methods comprising various aspects and embodiments described below in this document.

All or some of the algorithms and steps of the methods of FIGS. 3, 4, 6 and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 3, 4, 6 and 7.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 56, and other peripheral devices 57. The display system 15 of various embodiments includes one or more of, for example, a touchscreen display, an organic light-emitting diode (OLED) display, a curved display, and/or a foldable display. The display 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 13. For example, a disk player performs the function of playing an output of the system 13.

In various embodiments, control signals are communicated between the system 13 and the display system 15, speakers 56, or other peripheral devices 57 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel via the communication interface 5004. The display system 15 and speakers 56 can be integrated in a single unit with the other components of system 13 in an electronic device such as, for example, a television. In various embodiments, the display interface 532 includes a display driver, such as, for example, a timing controller (T Con) chip.

The display system 15 and speaker 56 can alternatively be separate from one or more of the other components. In various embodiments in which the display system 15 and speakers 56 are external components, the output signal can be provided via dedicated output connections, including, for example, HDMI ports, USB ports, or COMP outputs.

FIG. 5C illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 500 is interconnected to other elements of said system 11 by the bus 5005.

The communication interface 5004 of the processing module 500 allows the system 500 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for reconstruction motion information.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for predicting motion information.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

The following embodiments try to take advantage of the redundant (or residual) information existing in the encoding of the motion information in the form of an index on a MVP and a MVd.

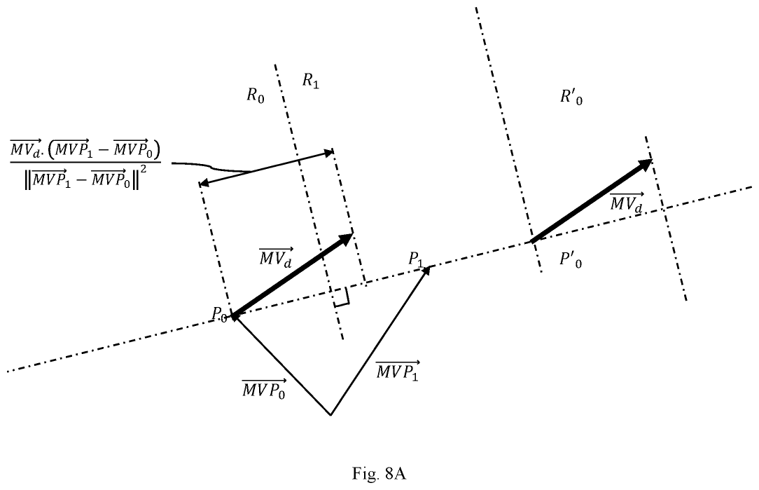

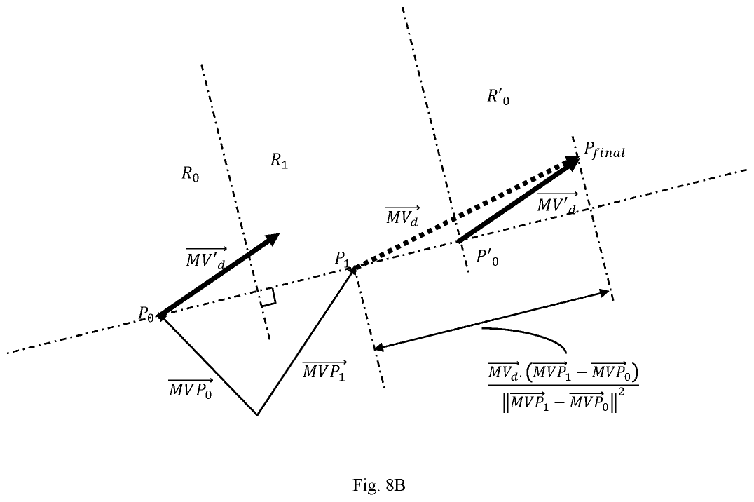

FIG. 8A illustrates an example of motion vector reconstruction process at decoder side of an embodiment.

Suppose a motion vector difference \vec{MV_{d}} as in FIG. 8A is signaled in video data along with a syntax element mvp_flag indicating a use of motion vector \vec{MVP₀} as the motion vector predictor of a current block.

In this embodiment, a decoding-side validity checking process is applied to determine a validity of the combination of \vec{MVP₀} (represented by the index mvp_flag) and \vec{MV_{d}}. The validity checking process is based on the following decoding-side criterion:

$$\vec{M {V}_{d}} \cdot ( \vec{{MVP}_{1}} - \vec{{MVP}_{0}} ) > \frac{1}{2} {‖ \vec{{MVP}_{1}} - \vec{{MVP}_{0}} ‖}^{2} \qquad ( Eq . 1 )$$

As can be seen, the decoding side criterion is calculated from the motion vector difference \vec{MV_{d}} and the motion information predictors of the AMVP list (i.e., \vec{MVP₀} and \vec{MVP₁}).

This decoding side criterion is easy to compute and is strictly equivalent to the following second decoding side criterion:

∥\vec{MV_{d}}∥²>∥\vec{MV_{d}}+\vec{MVP₀}−\vec{MVP₁}∥²

Geometrically, the decoding side validity checking process checks if the motion vector reconstructed with \vec{MVP₀} and \vec{MV_{d}} points to a spatial position that can be reached with a motion vector difference smaller than \vec{MV_{d}} in magnitude, and from motion vector \vec{MVP₁}. If this is the case, in this embodiment, the AMVP list is adapted to obtain an adapted list. The adaptation of the AMVP list consists in replacing the motion vector predictor \vec{MVP₀} by an alternative motion vector predictor \vec{MVP′₀}, so that the combination of \vec{MVP′₀} and \vec{MV_{d}} represents the motion vector that is actually reconstructed by the decoder. Spatial position

$${P}_{0}^{′}$$

shown by FIG. 8A. corresponds to the spatial position pointed to by the adaptive motion vector predictor \vec{MVP′₀}. Intuitively, from the illustration of FIG. 8A, one understands that the motion vector difference required to reach the target spatial position (\vec{MVP′₀}+\vec{MV_{d}}) starting from spatial position

$${P}_{0}^{′}$$

is of smaller magnitude than the MVD required when starting from spatial position P₁, hence leads to lower MVD coding rate cost.

The alternative motion vector predictor \vec{MVP′₀} is obtained as follows:

$$\vec{{MVP}_{0}^{′}} = \vec{{MVP}_{0}} + \frac{1}{2} ( \vec{{MVP}_{1}} - \vec{{MVP}_{0}} )$$

The combination of \vec{MVP′₀} and \vec{MV_{d}} is represented by a final motion vector \vec{MV}_{final}:

\vec{MV}_{final}=\vec{MVP′₀}+\vec{MV_{d}}

On FIG. 8A, the spatial region R₀ is the set of spatial positions that are reached from spatial position P₀ with a smaller MVD than from spatial position P₁, where P₀ and P₁ are the spatial positions pointed to respectively by \vec{MVP₀} and \vec{MVP₁}. The region R₁ is the set of spatial positions that are reached from spatial position P₁ with a smaller MVD than from spatial position P₁. Finally, the proposed embodiment leads to the establishment of a further spatial region

$${R}_{0}^{′} ,$$

shown on FIG. 8A. Region

$${R}_{0}^{′}$$

correspond to spatial positions that can be reached from position

$${P}_{0}^{′}$$

with a smaller MVD in magnitude than from both positions P₀ and P₁. As a consequence, thanks to the proposed embodiment, coding a motion vector pointing to a position in

$${R}_{0}^{′}$$

is achieved with smaller MVD magnitudes than in prior methods, hence reduced MVD coding cost. Thus, increased compression is expected from the proposed embodiment.

The decoding-side validity checking process is used together with a compliant encoding-side validity checking process illustrated by FIG. 8B.

Assume a motion vector \vec{MV}_{final} is to be encoded in video data for a current block. Motion vector \vec{MV}_{final} points to a spatial position P_{final} as shown in FIG. 8B. Position P_{final} is closer to position P₁ pointed to by \vec{MVP₁} than position P₀ pointed to by \vec{MVP₀}. In a usual process, the motion vector predictor \vec{MVP₁} is selected to predict the motion vector \vec{MV}_{final} and a motion vector difference \vec{MV_{d}} is computed between \vec{MVP₁} and \vec{MV}_{final}.

An encoding side validity checking process checks if the motion vector predictor \vec{MVP₁} and the motion vector difference \vec{MV_{d}} can be modified to produce a smaller motion vector difference magnitude, and in a way detectable by a decoder.

The encoding-side validity checking process comprises checking the following encoding side criterion:

\vec{MV_{d}}·(\vec{MVP₁}−\vec{MVP₀})>∥\vec{MVP₁}−\vec{MVP₀}∥² (Eq. 2)

This encoding-side validity checking process amounts at determining if the combination of \vec{MVP₀} and \vec{MV_{d}} form a valid combination.

If the encoding side criterion is verified, i.e., if the combination of \vec{MVP₀} and \vec{MV_{d}} is invalid, then the encoding module replaces the motion vector predictor \vec{MVP₀} by an alternative motion vector predictor \vec{MVP′₀}:

$$\vec{{MVP}_{0}^{′}} = \vec{{MVP}_{1}} + \frac{1}{2} ( \vec{{MVP}_{1}} - \vec{{MVP}_{0}} )$$

In addition, the motion vector difference to encode is modified to the following value:

\vec{MV′_{d}}=\vec{MVP₁}+\vec{MV_{d}}−\vec{MVP′₀}

This leads to

$$\vec{{MV}_{d}^{′}} = \vec{{MV}_{d}} - \frac{1}{2} ( \vec{{MVP}_{1}} - \vec{{MVP}_{0}} ) .$$

The following proves this alternative motion vector predictor \vec{MVP′₀} and the recomputed motion vector difference \vec{MV′_{d}} reduces the motion vector difference magnitude to code:

We have:

$${‖ \vec{{MV}_{d}^{′}} ‖}^{2} = {‖ \vec{{MV}_{d}} ‖}^{2} - \vec{{MV}_{d}} \cdot ( \vec{{MVP}_{1}} - \vec{{MVP}_{0}} ) + \frac{1}{4} {‖ \vec{{MVP}_{1}} - \vec{{MVP}_{0}} ‖}^{2}$$

In addition, we have:

\vec{MV_{d}}·(\vec{MVP₁}−\vec{MVP₀})>∥\vec{MVP₁}−\vec{MVP₀}∥²

Therefore:

$${‖ \vec{{MV}_{d}^{′}} ‖}^{2} < {‖ \vec{{MV}_{d}} ‖}^{2} - {‖ \vec{{MVP}_{1}} - \vec{{MVP}_{0}} ‖}^{2} + \frac{1}{4} {‖ \vec{{MVP}_{1}} - \vec{{MVP}_{0}} ‖}^{2} = {‖ \vec{{MV}_{d}} ‖}^{2} - \frac{3}{4} {‖ \vec{{MVP}_{1}} - \vec{{MVP}_{0}} ‖}^{2}$$

Thus, we have:

$${‖ \vec{{MV}_{d}^{′}} ‖}^{2} < {‖ \vec{{MV}_{d}} ‖}^{2}$$

The following proves the alternative motion vector predictor \vec{MVP′₀} and the recomputed motion vector difference \vec{MV′_{d}} leads to a configuration that is detectable by the decoder:

We have:

$$\vec{{MV}_{d}^{′}} \cdot ( \vec{{MVP}_{1}} - \vec{{MVP}_{0}} ) = ( \vec{{MV}_{d}} - \frac{1}{2} ( \vec{{MVP}_{1}} - \vec{{MVP}_{0}} ) . ( \vec{{MVP}_{1}} - \vec{{MVP}_{0}} ) )$$

$$\begin{matrix}\vec{{MV}_{d}^{′}} \cdot ( \vec{{MVP}_{1}} - \vec{{MVP}_{0}} ) = ( \vec{{MV}_{d}} - \frac{1}{2} ( \vec{{MVP}_{1}} - \vec{{MVP}_{0}} ) ) \cdot ( \vec{{MVP}_{1}} - \vec{{MVP}_{0}} ) \\ = \vec{{MV}_{d}} \cdot ( \vec{{MVP}_{1}} - \vec{{MVP}_{0}} ) - \frac{1}{2} {( \vec{{MVP}_{1}} - \vec{{MVP}_{0}} )}^{2} > \\ \frac{1}{2} {‖ \vec{{MVP}_{1}} - \vec{{MVP}_{0}} ‖}^{2} ( based on equation Eq . 2 )\end{matrix}$$

Therefore, the motion vector difference

$$\vec{{MV}_{d}^{′}}$$

fulfills the decoding-side criterion (Equation Eq. 1) if the motion vector difference

$$\vec{{MV}_{d}^{′}}$$

is signaled together with the use of \vec{MVP₀} as the motion vector predictor of the considered block.

It is then possible to signal a motion vector difference with reduced magnitude compared to what would be signaled in existing implementations, while making it possible to reconstruct the target final motion vector \vec{MV}_{final} on the decoder side.

Note the encoder side criterion of equation Eq. 2 can be generalized to the following expression:

$$\vec{{MV}_{d}} \cdot ( \vec{{MVP}_{1}} - \vec{{MVP}_{0}} ) > ( \frac{1}{2} + d ) \cdot {‖ \vec{{MVP}_{1}} - \vec{{MVP}_{0}} ‖}^{2} \qquad ( Eq . 3 )$$

Where d is a strictly positive value. Note in above exemplary embodiment, d has value ½. In that case, the alternative motion vector predictor \vec{MVP′₀} is computed as follows:

$$\\ {{MVP}_{0}^{′}}^{⟶} = {{MVP}_{1}}^{⟶} + d \cdot ( {{MVP}_{1}}^{⟶} - {{MVP}_{0}}^{⟶} )$$

The motion vector difference is given by:

$$\\ {{MV}_{d}^{′}}^{⟶} = {{MVP}_{1}}^{⟶} + {{MV}_{d}}^{⟶} - {{MVP}_{0}^{′}}^{⟶} = {{MV}_{d}}^{⟶} - d \cdot ( {{MVP}_{1}}^{⟶} - {{MVP}_{0}}^{⟶} )$$

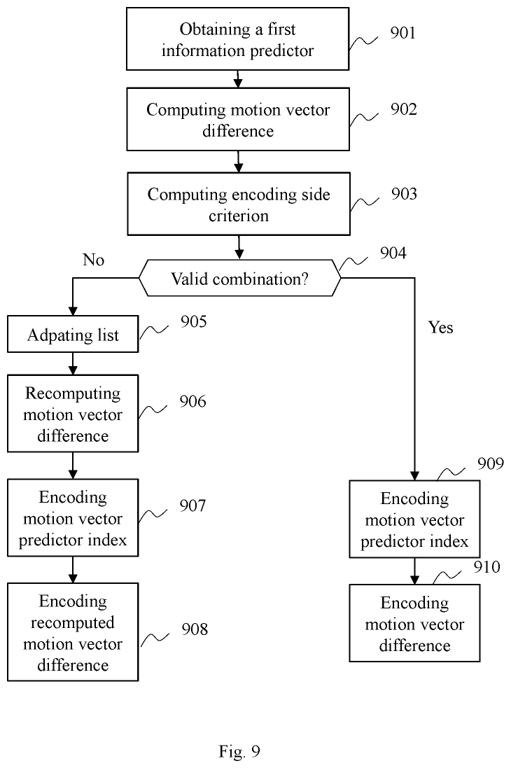

FIG. 9 illustrates an embodiment of an encoding algorithm.

The encoding algorithm is for example executed by the processing module 500 of the system 11 when the system 11 implements the encoding module of FIG. 3. The encoding algorithm is for example executed during step 308.

In a step 901, the processing module 500 obtains a motion vector predictor for a motion vector \vec{MV}_{final} of a current block (obtained in step 304). During step 901, the processing module 500 selects the motion vector predictor minimizing the motion vector difference among the motion vector predictor candidates

$$\\ {{MVP}_{0}}^{⟶} and {{MVP}_{1}}^{⟶}$$

of the AMVP list. The selected motion vector predictor candidate, noted

$$\\ {{MVP}_{idx}}^{⟶} ,$$

is represented by its index in the AMVP list idx.

In a step 902, the processing module 500 the motion vector difference \vec{MV_{d}}:

$$\\ {{MV}_{d}}^{⟶} = {{MV}^{⟶}}_{final} - {{MVP}^{⟶}}_{idx}$$

In step 903 and 904, the processing module 500 applies a validity checking process. The validity checking process comprises determining from the encoding side criterion of equation Eq. 3 that the non-selected motion vector predictor of the AMVP list MVP_{1-idx} and the motion information difference form a valid combination:

$$\vec{{MV}_{d}} \cdot ( \vec{{MVP}_{idx}} - \vec{{MVP}_{1 - idx}} ) > ( \frac{1}{2} + d ) \cdot {‖ \vec{{MVP}_{idx}} - \vec{{MVP}_{1 - idx}} ‖}^{2} \qquad ( Eq . 4 )$$

In step 903, the processing module 500 computes the encoding side criterion.

In step 904, the processing module 500 determines if the encoding side criterion is verified.

If the combination of \vec{MVP}_{1-idx} and the motion information difference \vec{MV_{d}} is valid (i.e., if the condition of the encoding side criterion is not verified), step 904 is followed by a step 909.

In step 909, the processing module 500 encodes the motion vector predictor index idx in the video data 311.

In a step 910, the processing module 500 encodes the motion vector difference \vec{MV_{d}} in the video data 311.

If the combination of \vec{MVP}_{1-idx} and the motion information difference \vec{MV_{d}} is not valid (i.e., if the condition of the encoding side criterion is fulfilled), step 904 is followed by a step 905.

During step 905, the processing module 500 adapt the AMVP list to obtain an adapted list. The adapting of the AMVP list comprises replacing the motion vector predictor candidate \vec{MVP}_{1-idx} by an alternative motion vector predictor \vec{MVP′_{1-idx}}:

\vec{MVP′_{1-idx}}=\vec{MVP_{idx}}+d·(\vec{MVP_{idx}}−\vec{MVP_{1-idx}})

In a step 906, the processing module 500 recomputes the motion vector difference based on the adapted list. The recomputed motion vector difference \vec{MV′_{d}} is computed as follows:

\vec{MV′_{d}}=\vec{MV_{d}}−d·(\vec{MVP_{idx}}−\vec{MVP_{1-idx}})

In a step 907, the processing module 500 encodes the motion vector predictor index 1-idx in the video data 311.

In a step 908, the processing module 500 encodes the motion vector difference \vec{MV′_{d}} in the video data 311.

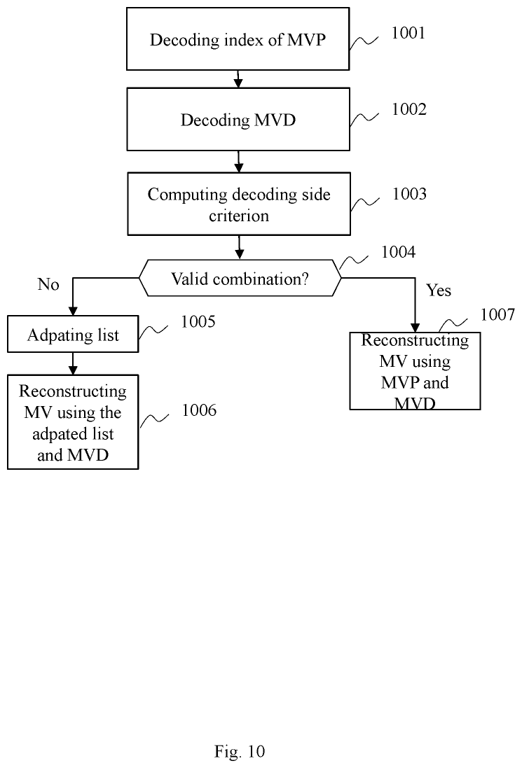

FIG. 10 illustrates an embodiment of a decoding algorithm.

The decoding algorithm is for example executed by the processing module 500 of the system 13 when the system 13 implements the decoding module of FIG. 4. The decoding algorithm is for example executed during step 408.

In a step 1001, the processing module decodes an index idx^{Dec} of a motion vector predictor for a current block from the video data 311. This index idx^{Dec} identifies a motion vector predictor among the motion vector predictor candidates \vec{MVP₀} and \vec{MVP₁} of the AMVP list.

In a step 1002, the processing module 500 decodes a motion vector difference

$$\vec{{MV}_{d}^{D e c}}$$

for the current block from the video data 311.

In steps 1003 and 1004, the processing module 500 applies a decoding-side validity checking process.

The decoding-side validity checking process comprises determining from the decoding-side criterion of equation Eq. 1 that the motion information predictor {right arrow over (MVP_{idx}_{^{Dec}})} indicated by the index idx^{Dec} and the motion information difference

$$\vec{{MV}_{d}^{D e c}}$$

form a valid combination.

In step 1003, the processing module 500 computes the decoding side criterion:

$$\vec{{MV}_{d}^{Dec}} . ( {\vec{MVP}}_{1 - {idx}^{Dec}} - {\vec{MVP}}_{{idx}^{Dec}} ) > \frac{1}{2} {‖ \vec{{MVP}_{1 - {idx}^{Dec}}} - \vec{{MVP}_{{idx}^{Dec}}} ‖}^{2}$$

As can be seen, the equation above is a generalization of the equation Eq. 1.

In step 1004, the processing module 500 determines if the combination is valid, i.e. if the above decoding-side criterion is not fulfilled.

If the combination is valid, in a step 1007, the processing module 500 reconstructs the motion vector of the current block \vec{MV}_{final} as the sum between the motion vector predictor

$$\vec{{MVP}_{{idx}^{Dec}}}$$

and the motion vector difference

$$\vec{{MV}_{d}^{D e c}} :$$

$${\vec{MV}}_{final} = \vec{{MVP}_{{idx}^{Dec}}} + \vec{{MV}_{d}^{D e c}}$$

If the combination is not valid (i.e. if the decoding-side criterion is fulfilled), in a step 1005, the processing module 500 adapt the AMVP list to obtain an adapted list.

The adaptation of the AMVP list comprises replacing the motion vector predictor {right arrow over (MVP_{idx}_{^{Dec}})} by an alternative motion vector predictor {right arrow over (MVP′_{idx}_{^{Dec}})}:

{right arrow over (MVP′_{idx}_{^{Dec}})}={right arrow over (MVP_{1-idx}_{^{Dec}})}+d·({right arrow over (MVP_{1-idx}_{^{Dec}})}−{right arrow over (MVP_{idx}_{^{Dec}})})

In a step 1006, the processing module 500 reconstructs the motion vector of the current block \vec{MV}_{final} as the sum between the motion vector predictor {right arrow over (MVP′_{idx}_{^{Dec}})} and the motion vector difference

$$\vec{M {V}_{d}^{D e c}} :$$

$${\vec{MV}}_{final} = \vec{{MVP}_{{idx}^{Dec}}^{′}} + \vec{{MV}_{d}^{D e c}}$$

In a first variant, more variety is given for choosing the alternative motion vector predictor by offering the possibility of using the zero-motion-vector. To do so, when the decoding-side criterion indicates that the combination of {right arrow over (MVP_{idx}_{^{Dec}})}, and the motion information difference

$$\vec{{MV}_{d}^{D e c}}$$

is not valid, an additional decoding-side criterion is computed during step 1005 to determine if the alternative motion vector predictor is the one computed in step 1005 (i.e., MVP′_{idx}_{^{Dec}}) or is the zero-motion-vector.

For example, the additional decoding-side criterion consists in checking the following condition:

∥\vec{MV_{D}∥}²<ε·min(∥\vec{MVP₀}∥²,∥\vec{MVP₁}∥²)

where 0<ε<1, and min(a,b) gives the minimum between a and b.

Responsive to decoding-side criterion and the second decoding side criterion are both fulfilled, then, during step 1005, the motion vector predictor {right arrow over (MVP_{idx}_{^{Dec}})} is replaced by the zero-motion vector.

In this first variant, when the decoding-side criterion is applied by the processing module 500 of the system 13, an additional encoding-side criterion identical to the additional decoding-side criterion is applied by the processing module 500 of the system 11 in step 905 to determine if the alternative motion vector predictor is the one computed in step 905 (i.e., \vec{MVP′_{1-idx}}) or is the zero-motion-vector.

In a second variant, the decoding-side criterion of equation Eq. 1 is used by the encoding module and the decoding module. To avoid confusion, the decoding-side criterion of equation Eq. 1 is called validity criterion in the following and is used in its generalized form represented by equation Eq. 5 below:

$$\vec{{MV}_{d}} \cdot ( \vec{{MVP}_{idx}} - \vec{{MVP}_{1 - idx}} ) > \frac{1}{2} \cdot {‖ \vec{{MVP}_{dx}} - \vec{{MVP}_{1 - idx}} ‖}^{2} \qquad ( Eq . 5 )$$

When the validity criterion of equation Eq. 5 is fulfilled, the encoding and the decoding modules consider a next candidate in the succession of potential candidates considered during the AMVP and/or merge candidates list construction process. For instance, w.r.t. AMVP, spatial candidates, a temporal motion vector candidate, HMVP candidates and then the zero-motion candidate may be considered during the AMVP candidate list construction process. In the second variant, potential candidates considered in the process for constructing a list of motion vector predictors are used to generate a further motion vector predictor, noted \vec{MVPₙₑₓₜ}, different from \vec{MVP₀} and \vec{MVP₁}. The second variant allows to diversify the set of potential motion vector predictors that can be used in combination with a given motion vector difference \vec{MV_{d}}.

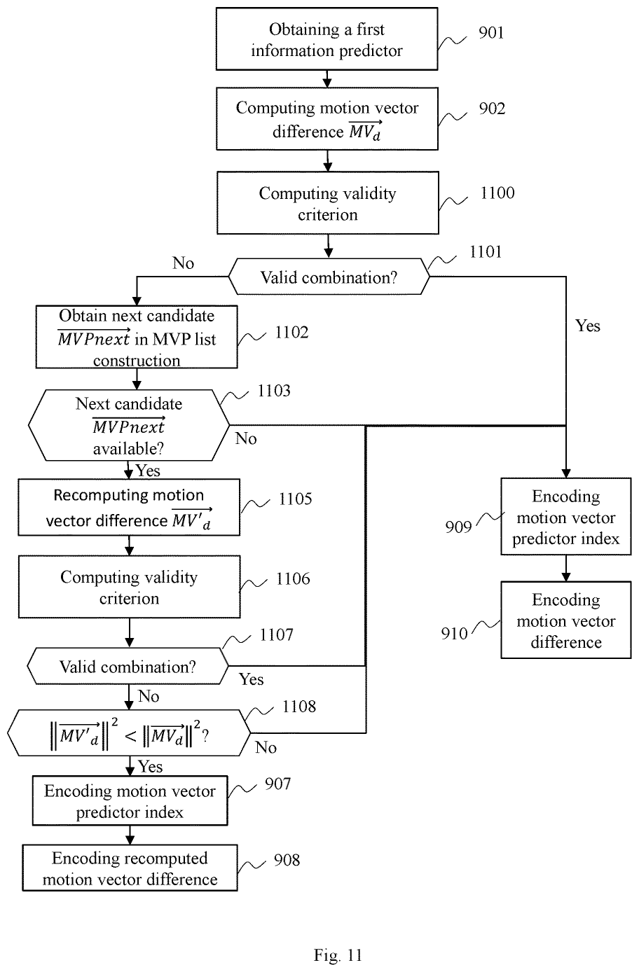

FIG. 11 illustrates an embodiment of an encoding algorithm compliant with the second variant.

The encoding algorithm of FIG. 11 is for example executed by the processing module 500 of the system 11 when the system 11 implements the encoding module of FIG. 3. The encoding algorithm of FIG. 11 is for example executed during step 308.

Steps 901, 902, 909 and 910 remains unchanged compared to the algorithm of FIG. 9.

In steps 1100 and 1101, the processing module 500 applies a validity checking process. The validity checking process comprises determining from the validity criterion of equation Eq. 1 that the non-selected motion vector predictor of the AMVP list \vec{MVP}_{1-idx} and the motion information difference \vec{MV_{d}} form a valid combination:

$$\vec{{MV}_{d}} \cdot ( \vec{{MVP}_{idx}} - \vec{{MVP}_{1 - idx}} ) > ( \frac{1}{2} ) \cdot {‖ \vec{{MVP}_{idx}} - \vec{{MVP}_{1 - idx}} ‖}^{2}$$

In step 1100, the processing module 500 computes the validity criterion.

In step 1101, the processing module 500 determines if the validity criterion is verified.

If the combination of \vec{MVP}_{1-idx} and the motion information difference \vec{MV_{d}} is not valid (i.e., if the condition of the validity criterion is fulfilled), step 1101 is followed by a step 1102.

In the step 1102, the processing module 500 tries to obtain a next candidate \vec{MVPₙₑₓₜ} from the potential candidates considered during the AMVP and/or merge candidates list construction process. For instance, the next candidate \vec{MVPₙₑₓₜ} is the first candidate from the potential candidates considered during the AMVP and/or merge candidates list construction process different from \vec{MVP₀} and \vec{MVP₁}.

In a step 1103, the processing module 500 determines if a next candidate can be obtained.

If no next candidate can be obtained, the processing module 500 continues with step 909.

Otherwise, step 1103 is followed by a step 1105. During step 1105, the processing module 500 recomputes a motion vector difference \vec{MV′_{d}} between the motion vector \vec{MV}_{final} of a current block and the next candidate \vec{MVPₙₑₓₜ}

\vec{MV′_{d}}=\vec{MV}_{final}−\vec{MVPₙₑₓₜ}

In a step 1106, the processing module 500 computes the validity criterion on the combination of the motion vector difference \vec{MV′_{d}} and the non-selected motion vector predictor of the AMVP list \vec{MVP}_{1-idx}:

$$\vec{{MV}_{d}^{′}} ( \vec{{MVP}_{idx}} - \vec{{MVP}_{1 - idx}} ) > ( \frac{1}{2} ) \cdot {‖ \vec{{MVP}_{idx}} - \vec{{MVP}_{1 - idx}} ‖}^{2} \qquad ( Eq . 6 )$$

As can be seen, Equation Eq. 6 correspond to equation Eq. 5 adapted to the combination of the motion vector difference \vec{MV′_{d}} and the non-selected motion vector predictor of the AMVP list \vec{MVP}_{1-idx}.

In a step 1107, the processing module 500 determines if the validity criterion is verified.

If the combination of \vec{MVP}_{1-idx} and the motion information difference \vec{MV′_{d}} is valid (i.e., if the condition of the above criterion of equation Eq. 5 is not verified), step 1107 is followed by a step 909.

If the combination of \vec{MVP}_{1-idx} and the motion information difference \vec{MV′_{d}} is not valid, step 1107 is followed by step 1108.

In step 1108, the processing module 500 compares the magnitude of the motion vector difference \vec{MV′_{d}} to the magnitude of the motion vector difference \vec{MV_{d}}. If ∥\vec{MV′_{d}}∥²≥∥\vec{MV_{d}}∥², step 1108 is followed by step 909.

If ∥\vec{MV′_{d}}∥²<∥\vec{MV_{d}}∥², step 1108 is followed by steps 907 and 908 already explained in relation to FIG. 9.

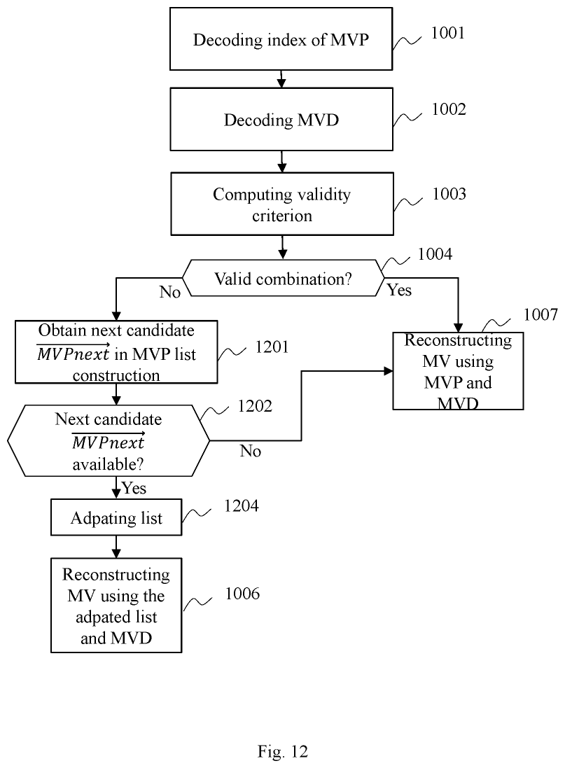

FIG. 12 illustrates an embodiment of a decoding algorithm compliant with the second variant.

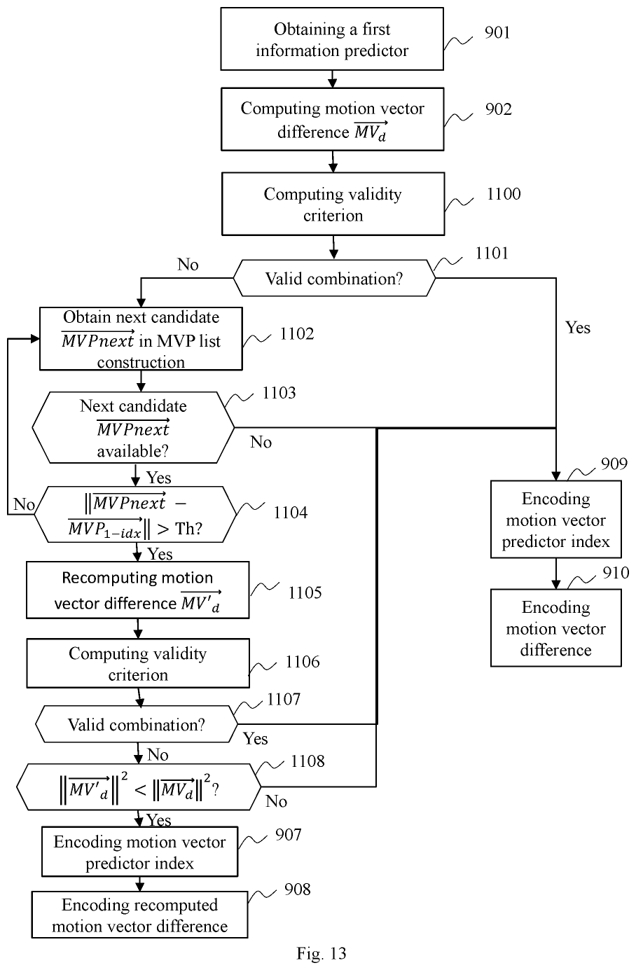

The encoding algorithm of FIG. 12 is for example executed by the processing module 500 of the system 13 when the system 13 implements the decoding module of FIG. 4. The encoding algorithm of FIG. 13 is for example executed during step 408.

Steps 1001, 1002, 1003, 1004 and 1007 remains unchanged compared to the algorithm of FIG. 10.

If the combination is not valid (i.e. if the validity criterion of equation Eq. 5 is fulfilled), step 1004 is followed by a step 1201.

During step 1201, the processing module 500 tries to obtain a next candidate \vec{MVPₙₑₓₜ} from the potential candidates considered during the AMVP and/or merge candidates list construction process. Again, for instance, the next candidate \vec{MVPₙₑₓₜ} is the first candidate from the potential candidates considered during the AMVP and/or merge candidates list construction process different from \vec{MVP₀} and \vec{MVP₁}.

In a step 1202, the processing module 500 determines if a next candidate can be obtained.

If no next candidate can be obtained, the processing module 500 continues with step 1007.

If a next candidate can be obtained, the processing module 500 applies a step 1204.

During step 1204 the processing module 500 adapts the AMVP list to obtain an adapted list.

The adaptation of the AMVP list comprises replacing the motion vector predictor {right arrow over (MVP_{idx}_{^{Dec}})} by an alternative motion vector predictor \vec{MVP′_{idx}^{Dec}}:

{right arrow over (MVP′_{idx}_{^{Dec}})}=MVPₙₑₓₜ

Step 1204 is followed by step 1006, already explained in relation to FIG. 10.

In a third variant, the validity criterion is used by the encoding module and the decoding module. When the validity criterion is fulfilled, the encoding and the decoding modules evaluate potential candidates considered during the AMVP and/or merge candidates list construction process (for instance, w.r.t. AMVP, spatial candidates, a temporal motion vector candidate, HMVP candidates and then the zero-motion) until finding a candidate sufficiently different from \vec{MVP_{1-idx}}. In the third variant, if a candidate sufficiently different from \vec{MVP_{1-idx}} is identified, this identified candidate is used to generate a further motion vector predictor, noted \vec{MVPₙₑₓₜ}, different from \vec{MVP₀} and \vec{MVP₁}. The third variant allows to increase the diversity of potential motion vector predictors that can be used in combination with a given motion vector difference \vec{MV_{d}}.

FIG. 13 illustrates an embodiment of an encoding algorithm compliant with the third variant.

The encoding algorithm of FIG. 13 is for example executed by the processing module 500 of the system 11 when the system 11 implements the encoding module of FIG. 3. The encoding algorithm of FIG. 13 is for example executed during step 308.

Steps 901, 902, 1100, 1101, 909 and 910 remains unchanged compared to the same steps in the algorithms of FIGS. 9 and 11.

If the combination of \vec{MVP}_{1-idx} and the motion information difference \vec{MV_{d}} is not valid (i.e., if the condition of validity criterion of Equation Eq. 5 is fulfilled), step 1101 is followed by an iterative process comprising steps 1102, 1103 and a new step 1104 allowing evaluating the potential candidates considered during the AMVP and/or merge candidates list construction process. Potential candidates are successively considered (i.e. run though) in the order in which they are considered for the construction of the AMVP and/or the merge list.

In the step 1102, the processing module 500 tries to obtain a next candidate \vec{MVPₙₑₓₜ} from the potential candidates considered during the AMVP and/or merge candidates list construction process.

In the step 1103, the processing module 500 determines if a next candidate can be obtained.

If no next candidate can be obtained, the processing module 500 continues with step 909.

Otherwise, step 1103 is followed by step 1104. During step 1104, the processing module 500 determines if the obtained candidate is sufficiently different from \vec{MVP_{1-idx}}. To do so, the processing module 500 compares, for example, the following metric to a value Th:

∥\vec{MVPnext}−\vec{MVP_{1-idx}}∥>Th

If ∥\vec{MVPnext}−\vec{MVP_{1-idx}}∥≤Th, the processing module 500 loops back to step 1102 to evaluate a new next candidate \vec{MVPₙₑₓₜ} from the potential candidates considered during the AMVP and/or merge candidates list construction process.

If ∥\vec{MVPnext}−\vec{MVP_{i-idx}}∥>Th, step 1104 is followed by steps 1105, 1106, 1107, 1108, 907, 908, 909 and 910 as already explained in relation to FIG. 11.

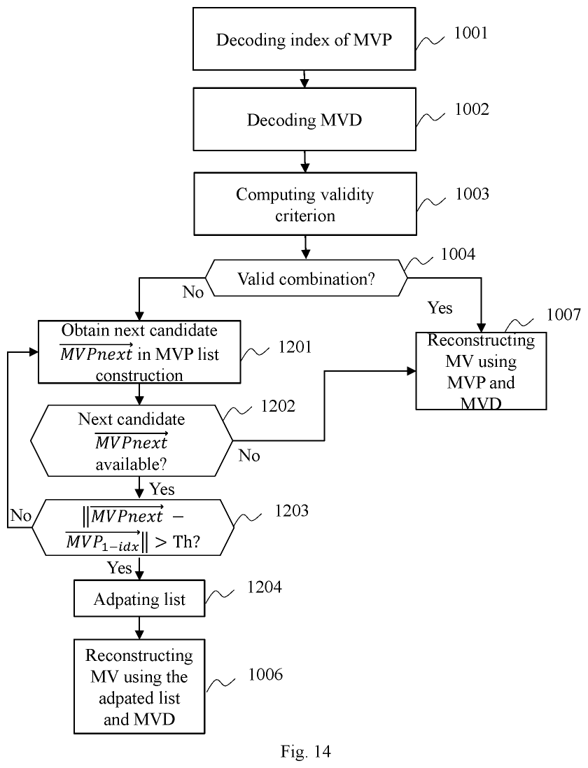

FIG. 14 illustrates an embodiment of a decoding algorithm compliant with the third variant.

The encoding algorithm of FIG. 14 is for example executed by the processing module 500 of the system 13 when the system 13 implements the decoding module of FIG. 4. The encoding algorithm of FIG. 13 is for example executed during step 408.

Again, steps 1001, 1002, 1003, 1004 and 1007 remains unchanged compared to the algorithm of FIG. 10.

If the combination is not valid (i.e., if the validity criterion of equation Eq. 5 is fulfilled), step 1004 is followed by an iterative process comprising steps 1201, 1202 and a new step 1203 allowing evaluating the potential candidates considered during the AMVP and/or merge candidates list construction process. Potential candidates are run though in the order in which they are considered for the construction of the AMVP and/or the merge list.

During step 1201, the processing module 500 tries to obtain a next candidate \vec{MVPₙₑₓₜ} from the potential candidates considered during the AMVP and/or merge candidates list construction process.

In a step 1202, the processing module 500 determines if a next candidate can be obtained.

If no next candidate can be obtained, the processing module 500 continues with step 1007.

If a next candidate can be obtained, the processing module 500 applies a step 1203.

During step 1203, the processing module 500 determines if the obtained candidate is sufficiently different from {right arrow over (MVP_{1-idx}_{^{Dec}})}. To do so, the processing module 500 compares, for example, the following metric to a value Th:

∥\vec{MVPnext}−MVP_{1-idx}_{^{Dec}}∥>Th

If ∥\vec{MVPnext}−{right arrow over (MVP_{1-idx}_{^{Dec}})}∥≤Th, the processing module 500 loops back to step 1201 to search a new next candidate \vec{MVPₙₑₓₜ} from the potential candidates considered during the AMVP and/or merge candidates list construction process.

If ∥\vec{MVPnext}−{right arrow over (MVP_{1-idx}_{^{Dec}})}∥>Th, step 1203 is followed by steps 1204 and 1006 as already explained in relation to FIG. 12.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1-34. (canceled)

35. A method comprising:
decoding an index of a first motion information predictor in an initial list of motion information predictors for a current block of a picture, the initial list comprising two motion information predictors;
decoding a motion information difference for the current block;
applying a validity checking process comprising determining that the first motion information predictor and the motion information difference form a valid combination, the first motion information predictor and the motion information difference forming a non-valid combination if it is determined that a first value representative of a multiplication of the motion information difference by a difference between the first motion information predictor and a second motion information predictor of the initial list is larger than a second value representative of a norm of a difference between the first motion information predictor and the second motion information predictor; and
adapting the initial list of motion information predictors to obtain an adapted list based on a result of the applying of the validity checking process.

36. The method of claim 35, wherein, responsive to the first motion information predictor and the motion information difference forming a non-valid combination, adapting the initial list comprises replacing the first motion information predictor by an alternative motion information predictor, the alternative motion information predictor being determined based on the motion information predictors of the initial list.

37. The method of claim 36, wherein, determining the alternative motion information predictor based on the motion information predictors of the initial list comprises comparing a norm of the motion information difference with a value representative of the lowest norm of norms of the motion information predictors of the initial list and selecting the alternative motion information predictor among a motion information predictor derived from the motion information predictors of the initial list and a zero motion vector based on a result of the comparing.

38. The method of claim 37, wherein the zero motion vector is selected responsive to a ratio between the norm of the motion information difference and a value representative of the lowest norm of the norms of the motion information predictors of the initial list being lower than a value.

39. The method of claim 35, wherein, responsive to the first motion information predictor and the motion information difference forming a non-valid combination, adapting the initial list comprises replacing the first motion information predictor by an alternative motion information predictor corresponding to a candidate selected among potential candidates considered during an adaptive motion vector prediction (AMVP) and/or merge candidates list construction process.

40. The method of claim 39, wherein, the selected candidate is such that a value representative of a difference between the selected candidate and the second motion information predictor is higher than a value.

41. The method of claim 36, comprising reconstructing the motion information of the current block as a sum of the alternative motion information predictor and the motion information difference.

42. A method comprising:
obtaining a first motion information predictor of an initial list of motion information predictors for a current block of a picture, the initial list comprising two motion information predictors;
computing a motion information difference between a motion information of the current block and the first motion information predictor;
applying a validity checking process comprising determining that a second motion information predictor of the initial list and the motion information difference form a valid combination, the second motion information predictor and the motion information difference forming a non-valid combination if it is determined that a first value representative of a multiplication of the motion information difference by a difference between the first motion information predictor and the second motion information predictor is larger than a second value representative of a norm of a difference between the first motion information predictor and the second motion information predictor; and
adapting the initial list of motion information predictors to obtain an adapted list based on a result of the applying of the validity checking process.

43. The method of claim 42, wherein, responsive to the second motion information predictor and the motion information difference forming a non-valid combination, adapting the initial list comprises replacing the second motion information predictor by an alternative motion information predictor, the alternative motion information predictor being determined based on the motion information predictors of the initial list; and recomputing the motion information difference based on the adapted list comprises recomputing the motion information difference as a difference between the motion information of the current block and the alternative motion information predictor to obtain a recomputed motion information difference.

44. The method of claim 42, wherein, responsive to the second motion information predictor and the motion information difference forming a non-valid combination, adapting the initial list comprises replacing the second motion information predictor by an alternative motion information predictor corresponding to a candidate selected among potential candidates considered during an AMVP and/or merge candidates list construction process.

45. The method of claim 44, wherein, the selected candidate is such that a value representative of a difference between the selected candidate and the second motion information predictor is higher than a value.

46. The method of claim 42, comprising encoding the motion information of the current block in the form of an index representative of the first motion information predictor and the recomputed motion information difference.

47. A device comprising electronic circuitry configured for:
decoding an index of a first motion information predictor in an initial list of motion information predictors for a current block of a picture, the initial list comprising two motion information predictors;
decoding a motion information difference for the current block; and,
applying a validity checking process comprising determining that the first motion information predictor and the motion information difference form a valid combination, the first motion information predictor and the motion information difference forming a non-valid combination if it is determined that a first value representative of a multiplication of the motion information difference by a difference between the first motion information predictor and a second motion information predictor of the initial list is larger than a second value representative of a norm of a difference between the first motion information predictor and the second motion information predictor; and,
adapting the initial list of motion information predictors to obtain an adapted list based on a result of the applying of the validity checking process.

48. The device of claim 47 wherein, responsive to the first motion information predictor and the motion information difference forming a non-valid combination, adapting the initial list comprises replacing the first motion information predictor by an alternative motion information predictor, the alternative motion information predictor being determined based on the motion information predictors of the initial list.

49. The device of claim 48, wherein, determining the alternative motion information predictor based on the motion information predictors of the initial list comprises comparing a norm of the motion information difference with a value representative of the lowest norm of norms of the motion information predictors of the initial list and selecting the alternative motion information predictor among a motion information predictor derived from the motion information predictors of the initial list and a zero motion vector based on a result of the comparing.

50. The device of claim 49, wherein the zero motion vector is selected responsive to a ratio between the norm of the motion information difference and a value representative of the lowest norm of the norms of the motion information predictors of the initial list is lower than a value.

51. The device of claim 47, wherein, responsive to the first motion information predictor and the motion information difference forming a non-valid combination, adapting the initial list comprises replacing the first motion information predictor by an alternative motion information predictor corresponding to a candidate selected among potential candidates considered during an AMVP and/or merge candidates list construction process.

52. The device of claim 51, wherein, the selected candidate is such that a value representative of a difference between the selected candidate and the second motion information predictor is higher than a value.

53. The device of claim 48, comprising reconstructing the motion information of the current block as a sum of the alternative motion information predictor and the motion information difference.

54. A device comprising electronic circuitry:
obtaining a first motion information predictor of an initial list of motion information predictors for a current block of a picture, the initial list comprising two motion information predictors;
computing a motion information difference between a motion information of the current block and the first motion information predictor;
applying a validity checking process comprising determining that a second motion information predictor of the initial list and the motion information difference form a valid combination, the second motion information predictor and the motion information difference forming a non-valid combination if it is determined that a first value representative of a multiplication of the motion information difference by a difference between the first motion information predictor and the second motion information predictor is larger than a second value representative of a norm of a difference between the first motion information predictor and the second motion information predictor; and,
adapting the initial list of motion information predictors to obtain an adapted list based on a result of the applying of the validity checking process.
